(19) United States
(12) Patent Application Publication
(10) Pub. No.: US 2010/0229402 A1
(43) Pub. Date: Sep. 16, 2010

(54) ADAPTOR FOR A LINE TRIMMER

(76) Inventor: Philip Ross Trethowan, Dural (AU)

Correspondence Address: DAVIS & BUJOLD, P.L.L.C., 112 PLEASANT STREET, CONCORD, NH, 03301, US

(21) Appl. No.: 12/600,778

(22) PCT Filed: Apr. 9, 2008
(86) PCT No.: PCT/AU2008/000503

§ 371 Date: Jan. 25, 2010

(30) Foreign Application Priority Data
May 9, 2007 (AU) 2007100372
May 23, 2007 (AU) 2007100408

(51) Int. Cl. A01D 34/82; A01D 34/416

(52) U.S. Cl. 30/296.1

(57) ABSTRACT

An adaptor for a line trimmer is disclosed including a mounting for mounting the adaptor to a line trimmer; and a support for maintaining the head of the line trimmer in spaced relationship to a grassy ground surface and allowing movement of the adaptor across the ground surface to thereby mow the grass by way of the head of the line trimmer.

### TECHNICAL FIELD

The present invention relates to line trimmers and particularly relates to an adaptor for a line trimmer.

### BACKGROUND OF THE INVENTION

In order to maintain a lawn it is typically necessary to maintain an inventory of tools to care for the lawn including a line trimmer for trimming lawn edges and around trees, and a lawn mower for mowing flat areas of the lawn. It would be advantageous to reduce the number of tools required to care for a lawn both from the perspective of reducing the cost of caring for a lawn, and to reduce the storage space required to store these tools when not in use.

### SUMMARY OF THE INVENTION

In a first aspect the present invention provides an adaptor for a line trimmer, the adaptor including: mounting means for mounting the adaptor to a line trimmer; and support means for maintaining the head of the line trimmer in spaced relationship to a grassy ground surface and allowing movement of the adaptor across the ground surface to thereby mow the grass by way of the head of the line trimmer.

The mounting means may include a bracket.

The bracket may be arranged to grip about the shaft of a line trimmer.

The bracket may be securable to the adaptor in one of a number of positions to provide for a degree of adjustment to accommodate line trimmers of various geometries.

The support means may include a number of wheels which bear against the ground surface.

The support means may include at least two wheels which are free to swivel.

The support means may include at least four wheels which are free to swivel.

The support means may be adjustable to maintain the head of the line trimmer in any one of a number of different heights above the ground surface.

The adaptor may further include a shroud which surrounds the head of the line trimmer.

### BRIEF DESCRIPTION OF THE DRAWINGS

An embodiment of the present invention will now be described, by way of example only, with reference to the accompanying drawings, in which:

FIG. 1 is a perspective view of known type of line trimmer;

FIG. 2 is a perspective view of a first embodiment of an adaptor for a line trimmer according to the invention;

FIG. 3 shows the adaptor of FIG. 2 attached to the line trimmer of FIG. 1;

FIG. 4 is a perspective view of a second embodiment of an adaptor for a line trimmer according to the invention;

FIG. 5 shows the adaptor of FIG. 4 attached to the line trimmer of FIG. 1;

FIGS. 6 & 7 are above perspective views of a third embodiment of an adaptor for a line trimmer according to the invention; and

FIGS. 8 & 9 are further views of the adaptor of FIGS. 6 & 7 with an alternative bracket attached.

### DETAILED DESCRIPTION OF THE PREFERRED EMBODIMENT

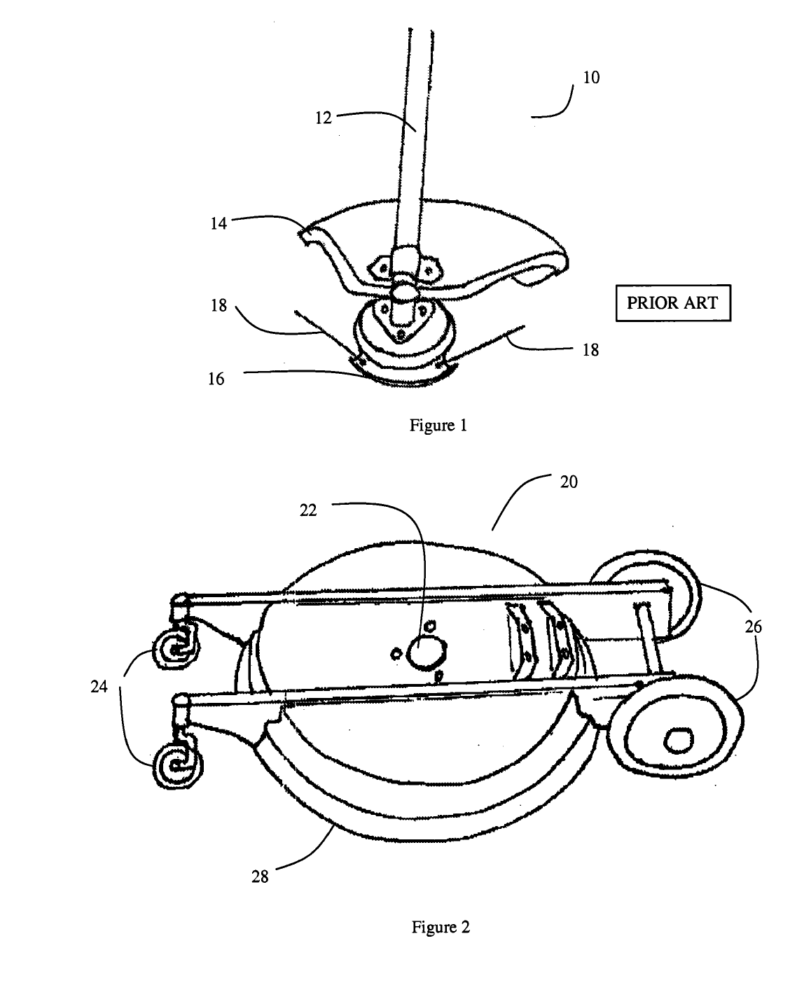

Referring to FIG. 1, a typical line trimmer 10 is shown having a shaft 12, a cutting head 16 including lengths of cutting line 18, and a shroud 14 which partially surrounds the cutting head 16 to protect a user from being injured by the spinning cutting wires during use. The trimmer 10 is of a type known as a straight shaft trimmer because the shaft 12 is straight along its length and meets and cutting head 16 at an angle of about 45 degrees.

Another common type of line trimmer is known as a bent shaft trimmer. In this case, the shaft of the trimmer extends vertically from the head 16 and a bend of approximately 45 degrees is provided at a point along the length of the shaft.

Upon depression of a trigger or other switch at the handle (not shown) of the shaft, the cutting head spins at high speed and any vegetation with which the cutting lines come into contact with is severed by the cutting lines. If the cutting lines become damaged, then they can be extended from a reel housed in the head, or are replaced.

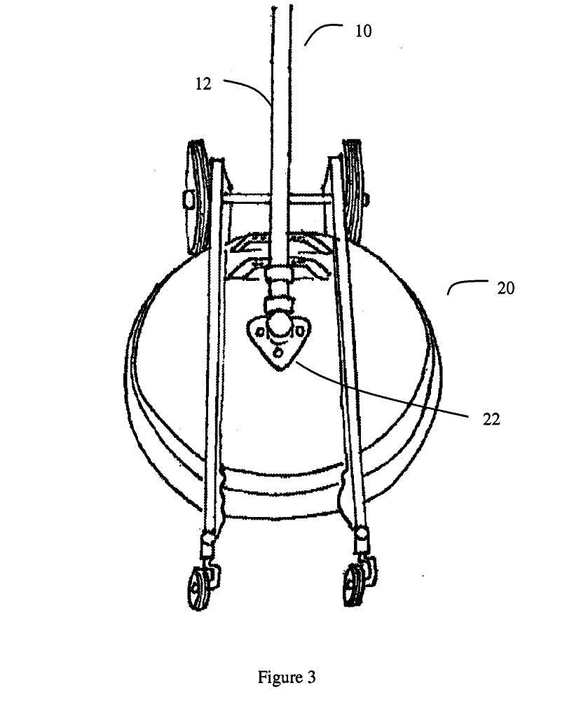

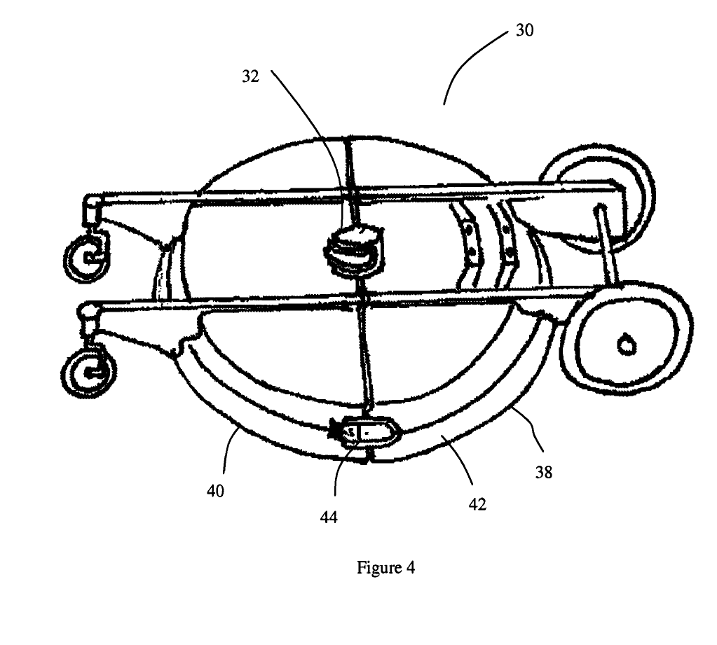

Referring to FIGS. 2 and 3, an adaptor 20 is shown for use with line trimmer 10. Adaptor includes a mounting means for mounting the line trimmer in the form of bracket 22 which is formed integrally with the shroud 28 of the adaptor. Adaptor further includes support means in the form of swivelling wheels 24 and fixed wheels 26 which serve to space bracket 22 away from the ground on which adaptor is positioned. The wheels allow the adaptor to travel over the ground.

Adaptor is fitted to trimmer 10 in the following manner. First, shroud 14 is removed from shaft 12 of trimmer 10 by releasing securing screws. Then, the shaft 12 of trimmer is inserted handle first through the underside of the adaptor through the hole of bracket 22 and secured by passing screws through the holes of bracket 22 to engage with the head 16 of trimmer 10.

With the adaptor in place, the head 16 of trimmer 10 is maintained at a fixed distance from the ground and the head is maintained in a position in which it is approximately parallel with the ground. Holding the handle of trimmer 10, the adaptor can be moved along the ground over a grassy area and thus the cutting lines of the spinning head 16 sever the grass to a fixed height. As adaptor is moved about over a lawn, the lawn is effectively mowed by the trimming head 16.

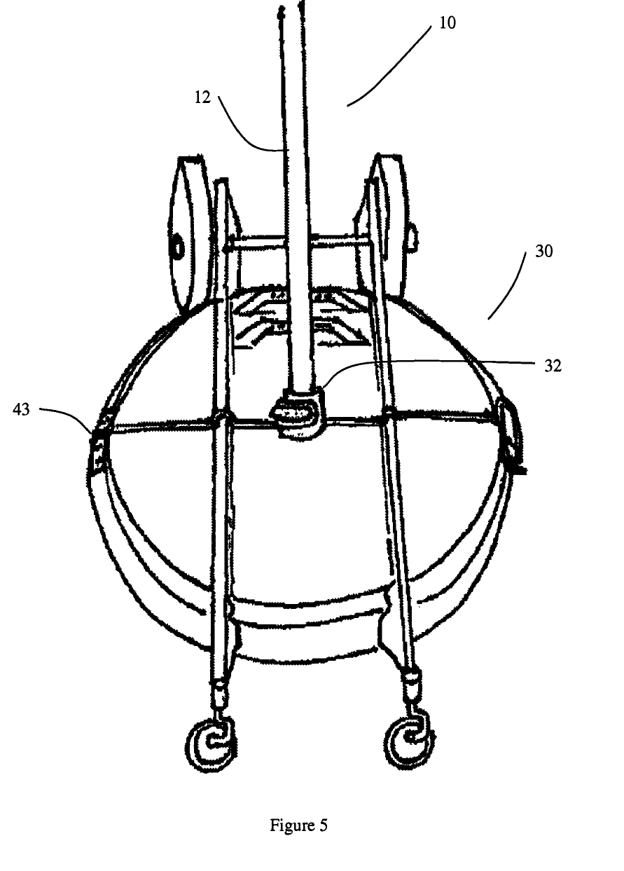

Referring to FIGS. 4 and 5, adaptor 30 differs from adaptor 20 in the manner of attachment of the line trimmer. Adaptor 30 is formed in two halves 40, 42 which are pivotally joined at hinge 43 (see FIG. 5). An adjustable bush 32 is provided in two halves, one half attached to either half of the adaptor. To attach to a line trimmer, buckle clasp 44 is released and the two adaptor halves are rotated apart. The halves are then placed about shaft 12 of line trimmer 10. The halves are then closed together so that the two halves of bush 32 grip about the shaft 12 and buckle clasp 44 is engaged. Operation is identical to adaptor 20 described above.

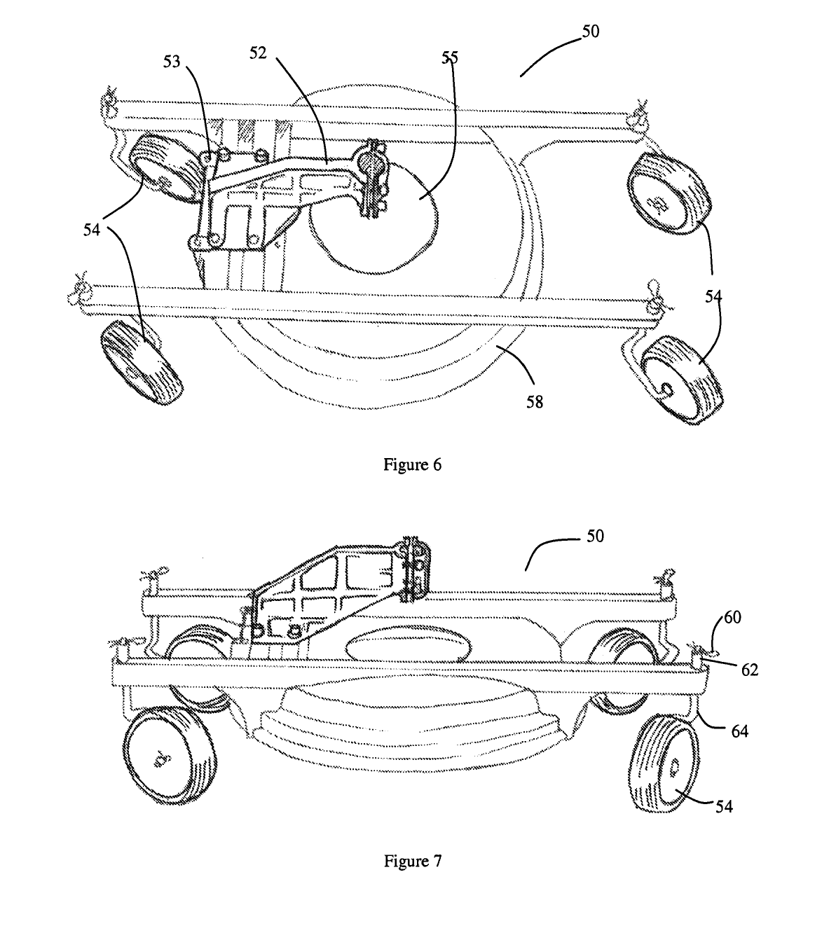

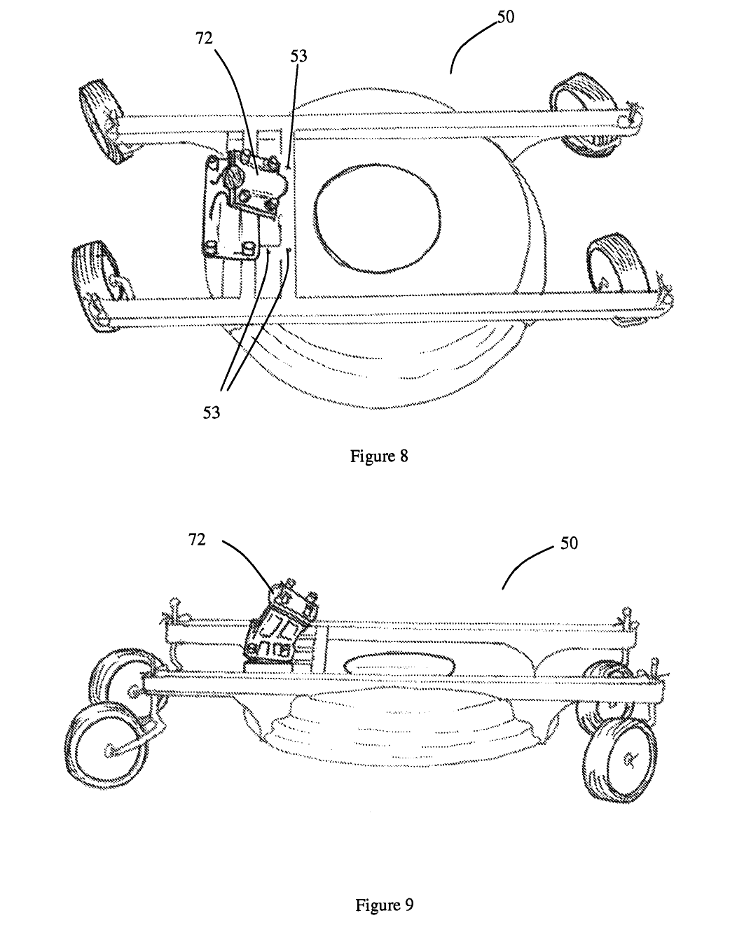

Referring to FIGS. 6 & 7, a further alternative adaptor 50 is shown. In this embodiment, mounting means is provided in the form of a removable bracket 52. Bracket engages with holes 53 provided on the adaptor. A number of pairs of holes 53 are provided and by selecting from these holes, the distance between the bracket 52 and aperture 55 may be adjusted. This allows accommodation of trimmers of varying geometries. In this embodiment, aperture 55 is sufficiently large that the line trimmer head 16 may be inserted through the aperture 55. The shaft 12 of the trimmer is then secured by bracket 52.

In this embodiment, all of the wheels 54 are identical in construction and are free to swivel. This provides increased manoeuvrability during use. Each of wheels 54 is mounted on an axle piece 64 which extends upwards from the wheel 54 and passes through and is free to pivot in a hole in the arm of adaptor 50. Each of the axle pieces 64 includes a lug (not shown) which limits their depth of insertion into adaptor 50. A bush 62 is provided on each axle and is secured by split pin 60. The height of the cutting head above the ground, and hence the length of the mown grass, may be adjusted by way of these bushes 62 as follows. First split pin 60 is released and the bush 62 removed. The axle 64 is then removed from the adaptor 50. The bush 62 is threaded onto axle 64 and abuts the lug (not shown) on axle 64 which is then re-inserted into the aperture in the adaptor 50 and the split pin 60 replaced. When this adjustment has been made to all four wheels then the height of the adaptor above the ground is increased by the height of bush 62. Various sizes of bushes may be provided to allow the adaptor 50 to be configured for a range of cutting heights.

Referring to FIGS. 8 and 9, adaptor 50 is shown in combination with an alternative style of bracket 72. This bracket is intended for use with straight shaft type line trimmers. Also evident from FIG. 8 are the alternative mounting holes 53. In all, 5 pairs of holes 53 are provided, thus allowing for three different mounting positions.

As well as being used to mow the lawn, the line trimmer 10 can of course be used in its conventional role for trimming and edging. It can be seen that embodiments of the invention allow a lawn to be mowed and trimmed by way of the line trimmer and the adaptor. A separate dedicated lawn mower is not required. This saves the cost of purchasing and maintaining a lawn mower and also saves on storage space.

The adapters according to the invention are typically formed from polyethylene and are rugged and lightweight. When not is use, the adapter according to the invention can be stowed away by hanging on a hook on a wall for instance. The storage space requirements are low.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1-10. (canceled)

11. An adaptor for a line trimmer, the adaptor comprising:
mounting means for mounting the adaptor to a line trimmer; and
support means for maintaining the head of the line trimmer in spaced relationship to a grassy ground surface and allowing movement of the adaptor across the ground surface thereby to mow the grass by way of the head of the line trimmer.

12. The adaptor according to claim 11, wherein the mounting means includes a bracket.

13. The adaptor according to claim 12, wherein the bracket is arranged to grip about the shaft of a line trimmer.

14. The adaptor according to claim 12, wherein the bracket is securable to the adaptor in one of a number of positions to provide for a degree of adjustment to accommodate lien trimmers of various geometries.

15. The adaptor according to claim 11, wherein the support means includes a number of wheels which bear against the ground surface.

16. The adaptor according to claim 15, wherein the support means includes at least two wheels which are free to swivel.

17. The adaptor according to claim 15, wherein the support means includes at least four wheels which are free to swivel.

18. The adaptor according to claim 11, wherein the support means is adjustable to maintain the head of the line trimmer in any one of a number of different heights above the ground surface.

19. The adaptor according to claim 11, further including a shroud which surrounds the head of the line trimmer.

20. The adaptor substantially as herein described with reference to the accompanying drawings.

21. The adaptor according to claim 13, wherein the bracket is securable to the adaptor in one of a number of positions to provide for a degree of adjustment to accommodate lien trimmers of various geometries.

22. An adaptor for a line trimmer, the adaptor comprising:
mounting mechanism for mounting the adaptor to a line trimmer; and
support mechanism for maintaining the head of the line trimmer in spaced relationship to a grassy ground surface and allowing movement of the adaptor across the ground surface thereby to mow the grass by way of the head of the line trimmer;
the mounting mechanism including a bracket being arranged to grip about the shaft of a line trimmer; and
the bracket being securable to the adaptor in one of a number of positions to provide for a degree of adjustment to accommodate lien trimmers of various geometries.

23. The adaptor according to claim 22, wherein the support mechanism includes a number of wheels which bear against the ground surface.

24. The adaptor according to claim 22, wherein the support mechanism ans includes at least two wheels which are free to swivel.

25. The adaptor according to claim 22, wherein the support mechanism includes at least four wheels which are free to swivel.

26. The adaptor according to claim 22, wherein the support mechanism is adjustable to maintain the head of the line trimmer in any one of a number of different heights above the ground surface.

27. The adaptor according to claim 22, further including a shroud which surrounds the head of the line trimmer.
